(19) United States
(12) Patent Application Publication
(10) Pub. No.: US 2012/0206003 A1
(43) Pub. Date: Aug. 16, 2012

(54) BRUSHLESS DIRECT CURRENT (DC) ELECTRIC GENERATOR WITH DECREASED ELECTROMAGNETIC DRAG

(76) Inventor: Robert Ray Holcomb, Nokomis, FL (US)

(21) Appl. No.: 13/503,559

(22) PCT Filed: Oct. 19, 2010
(86) PCT No.: PCT/IB2010/002663

§ 371 Date: Apr. 23, 2012

Related U.S. Application Data
(60) Provisional application No. 61/279,535, filed on Oct. 22, 2009.

(51) Int. Cl. H02K 16/02; H02K 53/00

(52) U.S. Cl. 310/114; 74/DIG. 9

(57) ABSTRACT

A method and apparatus for reducing drag in an electric generator are disclosed. Armature insert members are distributed along a periphery of a stator insert fit into a stator having induction windings arranged in slots. The armature insert members include permanent magnet rotors having a pair of pole sections with same magnetic polarity. The alignment of the armature insert members is offset in 45 degree increments. The armature insert members are rotated together in a synchronized manner such that the pole sections are sequentially rotated into alignment with the slots providing a moving excitation field. The stator insert and the stator are divided into sectors from a common center point. Armature insert members having a first magnetic polarity are inserted into positions around the outer periphery of the stator insert corresponding to first sectors and armature insert members having a second magnetic polarity are inserted into positions around the outer periphery of the stator insert corresponding to second ones of the N sectors, the first ones and the second ones of the N sectors arranged in alternating relation.

### FIELD

The present invention relates generally to a decreased drag electric power generating machine, and more particularly, to an electric machine that generates electric power through a series of rotating magnetic bars.

### BACKGROUND

Rapid consumption of exhaustible energy from the earth, largely in the form of fossil fuels and rapid depletion of associated energy resources and accompanying environmental pollution and climate change drives the clear need for alternative energy supplies. Existing energy supplies must be used more efficiently.

In view of these and other issues, the need for sustainable power generation units is obvious. Renewable energy sources such as solar, wind, hydroelectric, electrostatic, temperature differential and geothermal energy have significant problems of availability, reliability and expense. Even gravity, if it could be efficiently harnessed, could provide a most attractive alternative.

One contribution to increasing consumption efficiency and sustainability is to increase the efficiency of electrical power generation. Increasing the conversion efficiency associated with converting mechanical energy to electrical power can provide potentially large gains. An ordinary electric generator typically converts close to 99% of supplied mechanical power into electric power based on a conventional 100% conversion efficiency comparison factor of one horsepower per 746 watts generated, however such a factor is somewhat misleading as true efficiency that takes into account friction losses and the like, may be significantly less. Still further gains can be achieved using superconducting technology. For example, a superconducting generator can be around 10-times smaller than a conventional generator for the same output.

While such gains are attractive, the expenses and challenges of implementing superconducting solutions are well known. It is therefore also desirable to achieve efficiency gains that are centered around more conventional structures. For example, if the reaction force or magnetic drag can be reduced or eliminated from the armature of an alternating current (AC) or direct current (DC) generator, the efficiency could be theoretically increased by 400-500%. Under such an increase in efficiency, one horsepower could generate up to 3,730 watts. Still further, by combining superconductivity with reduced magnetic drag, a greater than 10-fold increase in efficiency may be possible.

To better understand the rudiments of power generation, it is commonly known that every atom has a nucleus composed of positively charged protons and uncharged neutrons. Negatively charged electrons orbit the nucleus. In most atoms, the number of electrons is equal to the number of protons in the nucleus, so that there is no net charge. If the number of electrons is less than the number of protons, then the atom has a net positive charge. If the number of electrons is greater than the number of protons, then the atom has a net negative charge.

While on an aggregate scale, the universe is electrically neutral, local concentrations of charge throughout biological and physical systems are responsible for all electrical activity. Further, not all electrons are involved in the structure of material. Vast numbers of electrons which are loosely bound “electrons at large” are in equilibrium with outer shell electrons of atoms in the environment. It is from this pool of electrons in the atmosphere and in the ground, when set into combined motion along a path, that an electric current is generated. Thus, if electrical pressure from a generator is applied to an electrical conductor, such as copper wire, and the circuit closed, electrons will flow along the wire from negative to positive, from atom to atom forming an electric current.

The movement of energy associated with electrical current flow occurs at the speed of light, or approximately 186,000 miles per second.

For conceptual purposes, a wire connected to a DC power source will cause electrons to flow through the wire in a manner approximating water flowing through a pipe. The path of any one electron can be anywhere within the volume of the wire or even at the surface. When an AC voltage is applied across a wire it will cause electrons to vibrate back and forth in such a manner as to generate magnetic fields that push electrons toward the surface of the wire. As the frequency of the applied AC signal increases, the electrons are pushed farther away from the center and toward the surface.

A conventional electric power generator contains two main parts: a stator and a rotor. The stator is generally made of iron or other ferro-magnetic material and contains longitudinal slots having a certain depth and width and in which wire coils are wound in such a fashion to allow electric power to be generated when magnetic fields emanating from the rotor move past the coils. The rotor contains a specific arrangement of magnets, which are generally wound armature electro-magnets whose strength is governed by the amount of current flowing in the armature windings. It should be noted that, while permanent magnets have attractive properties, the use of permanent magnets, particularly in large scale applications, have traditionally been avoided due to the relatively high cost of magnetic material. When the rotor spins inside the stator, the magnetic fields from the rotor induce a current in the stator windings thus generating what is referred to as electrical power.

The energy required to spin the rotor is typically supplied by a drive unit of some kind, such as an electrical drive motor, diesel or other fossil fuel motor, steam turbine or the like. At typical efficiencies, only 20% of the energy input by the driver motor is devoted to creating electric power. The remaining 80% is dissipated by magnetic drag, or braking forces, that develop between the rotor and the stator.

When current is supplied to a load from a conventional generator, a magnetic force or reaction force is created by the flow of the load current in the generator conductors that opposes the rotation of the generator armature. If the load current in the generator conductors increases, the drag associated with the reaction force increases. More force must be applied to the armature as the load increases to keep the armature from slowing. Increasing drag and increasing load current leads to decreasing conversion efficiency and can eventually lead to destructive consequences for generator equipment.

It would be desirable for a way of increasing generator efficiency by reducing the motor reaction effect and the corresponding negative consequences.

### SUMMARY

Various exemplary embodiments are discussed and described herein involving aspects of an electric machine, such as a brushless, commutatorless DC generator that produces power with high efficiency and low drag.

Accordingly, an exemplary method for reducing drag in a brushless direct current (DC) electric generator can include distributing armature insert members along an outer periphery of a stator insert. The stator insert can be affixed inside, coupled to or otherwise tightly inserted, such as press fit, into a stator having induction windings arranged in slots around the inner periphery. The armature insert members can include permanent magnet rotors each having a pair of pole sections, with each pole section having the same magnetic polarity, such as either both north poles or both south poles. The alignment of the armature insert members can be offset in 45 degree increments from one to the next. The armature insert members can be rotated together in a synchronized manner such that the pole sections of the armature insert members are sequentially rotated into alignment with the slots. The rotation thereby provides a moving excitation field having maximum flux density in the induction windings to induce a current flow. It should be noted that the stator insert and the stator can be divided along radii emanating from a common center point on a common central longitudinal axis into N equally spaced sectors, where N can be a positive integer, such as, for example, 8.

First armature insert members having the first magnetic polarity are inserted into first positions along the outer periphery of the stator insert corresponding to first sectors and second armature insert members of the second magnetic polarity are inserted into second positions along the outer periphery of the stator insert corresponding to second sectors resulting in an arrangement where alternating ones of the sectors contain armature insert members having alternate magnetic polarity. In other words, in an exemplary embodiment, in first sector, all of the armature insert members can have a north polarity, and in a next sector, all of the armature insert members can have a south polarity and so on. While the above alternating arrangement is described in accordance with one embodiment, other arrangements are possible. The slots and the armature insert members are axially aligned along respective lengthwise axes thereof such that a lengthwise axis of each of the armature insert members is in normal alignment with a depthwise axis of each of the slots. The armature insert members can be magnetically shielded within the stator insert such that flux generated thereby is directed into the slots so as to minimize flux leakage and magnetic drag. The armature insert members can be inserted into respective openings provided in the first and the second stator sections that are arranged in lengthwise alignment with the slots in order to partially shield the first and the second members. Each of the armature insert members can have a longitudinal opening corresponding to a longitudinal opening of the slots, to provide magnetic communication with the corresponding longitudinal opening in the slots.

The armature insert members, such as the first armature insert member and the second armature insert member noted above, can be rotated, driven, or the like, in a synchronized manner such that first ones of the armature insert members in a first sector and having the pair of pole sections of the first magnetic polarity are sequentially rotated into alignment with the slots in the first sector while the second ones of the armature inserts members in a second sector and having the pair of pole sections of the second magnetic polarity are sequentially rotated into alignment with the slots associated with the second sector so as to provide a moving excitation field having maximum flux density in the induction windings to induce a current flow therein. The pole sections can be formed from neodymium, samarium-cobalt or the like.

In another embodiment, an electromagnetic assembly can be provided for a brushless direct current (DC) electric generator. A stator is provided having a plurality of slots arranged on a stator periphery thereof each of the slots having a lengthwise and depthwise axis, each of the plurality of slots having induction coil windings disposed therein. A stator insert, that can be inserted, press fit or the like, can be provided that has a plurality of cavities on a stator insert periphery, the plurality of cavities having longitudinal axes aligned with the respective longitudinal axis of each of the plurality of slots. The stator and the stator insert can be circular in shape and can be concentrically arranged. A plurality of armature insert members each having permanent magnet rotors can be inserted into the cavities. Each permanent magnet rotor can have a pair of magnetic pole sections. Each pole section can have a same magnetic polarity, such as a first magnetic polarity or a second magnetic polarity. Each of the plurality of armature insert members can correspond to each of the plurality of slots and can be capable of rotating about a longitudinal axis through, for example, a drive gear provided on an end thereof. Each of the plurality of the armature insert members can be disposed respectively above each of the plurality of the slots such that the induction coil windings disposed in the plurality of slots are exposed to magnetic flux generated by the magnetic pole sections. The plurality of armature insert members can be offset from each other by an angle of 45 degrees or, in connection with various embodiments and alternative embodiments, angles other than 45 degrees, and can be capable of rotating in synchronized relation such that such that the pole sections of the armature insert members are sequentially rotated into alignment with the slots so as to provide a moving excitation field having maximum flux density in the induction windings to induce a current flow.

The stator insert and the stator can be divided into N equally spaced sectors, such as 8 sectors, by radii emanating from a common center point on a common central longitudinal axis. First ones of the armature insert members of the first magnetic polarity are inserted into first positions along the outer periphery of the stator insert corresponding to a first one of the N sectors and second ones of the armature insert members of the second magnetic polarity are inserted into second positions along the outer periphery of the stator insert corresponding to second ones of the N sectors, the first ones and the second ones of the N sectors arranged in alternating relation. A back iron can be disposed around an outer periphery of the stator.

In an embodiment, each of the cavities has an opening positioned over the slots, each of the plurality of armature insert members includes a containment sleeve made from alternating layers of mu metal and austenitic steel that shields the stator insert from magnetic fields produced by each of the armature insert. The containment sleeve can be provided with one or more bearings to support rotation of the containment sleeve and the contained armature insert member. The containment sleeve can be further provided with a gear coupled to an end thereof for rotating the containment sleeve and the contained armature insert about the longitudinal axis.

It is a principal object of the above and other embodiments, to provide a method and process for construction of a brushless DC electric generator with reduced drag and therefore greater efficiency.

It is an additional object to provide a process for allowing the magnification of electric power through the use of a standard electric motor which drives a generator having a higher efficiency than that of the electric motor drive.

It is an additional object to provide a method by which a standard electric generator may be retrofitted to greatly decrease electromagnetic drag and produce electric power at greater efficiency.

### BRIEF DESCRIPTION OF THE DRAWINGS

In order that embodiments may be fully and more clearly understood by way of non-limitative examples, the following description is taken in conjunction with the accompanying drawings in which like reference numerals designate similar or corresponding elements, regions and portions, and in which:

FIG. 1A is a diagram illustrating an end view of a stator unobstructed by housing or end bells, and containing exemplary armature inserts in accordance with one or more embodiments;

FIG. 1B is a diagram illustrating details of a section of a stator and slot numbers in accordance with one or more embodiments;

FIG. 2 is a diagram illustrating an exemplary stator insert portion including cylinder insert portions capable of housing exemplary armature inserts in accordance with one or more embodiments;

FIG. 3 is a diagram illustrating a cross section of an exemplary armature insert including a magnetic north dipole contained within a laminated metal sleeve contained in a cylinder insert portion in accordance with one or more embodiments;

FIG. 4 is a diagram illustrating an exemplary containment sleeve for an armature insert including bearings and gear mechanism in accordance with one or more embodiments;

FIG. 5 is a diagram illustrating a superior lateral projection of an exemplary containment sleeve of FIG. 4 inserted into a cylinder insert portion in accordance with one or more embodiments;

FIG. 6 is a diagram illustrating a lateral oblique view of end bells accommodating an exemplary gear drive mechanism for exemplary armature inserts in accordance with one or more embodiments;

FIG. 7 is a diagram illustrating a lateral oblique projection of a stator;

FIG. 8 is a diagram illustrating exemplary relative positions of an exemplary armature insert during synchronous rotation of the north pole through 180° of electrical rotation of the excitation field in accordance with one or more embodiments;

FIG. 9 is a diagram illustrating exemplary relative positions of an exemplary armature insert during synchronous rotation of the south pole through 180° of electrical rotation of the excitation field in accordance with one or more embodiments; and

FIG. 10 is a diagram illustrating an exemplary construction of a bipolar magnetic body with identical functional poles on each exposed surface.

### DETAILED DESCRIPTION

In accordance with various exemplary embodiments discussed and described herein, and by way of brief summary, motor reaction force may be reduced and other problems can be solved in an embodiment where a stator insert into which is inserted shielded bipolar permanent magnets, also known as slot rotors or the like, but which are referred to herein as armature inserts, that rotate on their axis over each wire slot of the stator can constitute an inventive generator. The permanent magnets of the armature inserts can be contained within a shielded laminated cylinder that can be constituted of mu metal and can be laminated, for example, using steel, such as austenitic stainless steel lamination pieces or the like. The cylinder serves to shield the laminated ferromagnetic pole pieces of the stator from the magnetic fields generated by the permanent magnets of the armature inserts such that only the winding slots are exposed thereto. The cylinder may be constituted at the same length as the slots.

The magnets of the armature inserts may be arranged over portions of the induction coils such that groups of armature inserts with north poles are alternated with groups of armature inserts with south poles. The armature inserts are individually exposed to respective wire slots. The permanent magnets of the armature inserts having north/north and south/south poles are structured by bringing like poles together separated by a shielding lamination constituted of, for example two layers of mu metal sheeting sandwiching a sheeting of, for example, steel, such as non-magnetic austenitic steel material for strength and added shielding. The pole pieces can be glued together by epoxy cement or otherwise permanently fixed so that the magnetic pole bodies are aligned with a north pole on both exposed poles and a south pole on both exposed poles. The armature inserts are contained in a cylindrical cavity that is positioned in close proximity to a respective wire slot. The armature inserts can be contained within, for example, an austenitic stainless steel cylinder which is pressed into a cavity of an insert that is further pressed into a stator containing the induction coils. A drive unit, constituted as a cylinder can be fashioned on a shaft and inserted into the opening of the stator insert. The circumference of the end portions of the drive unit can be provided with gear teeth that mesh with gear teeth provided on each end of the armature inserts, and, in particular, a cylindrical containment sleeve for enclosing the permanent magnets of the armature inserts and helping to position the armature inserts over each slot of the generator. As the armature inserts and permanent magnets thereof are spun by the drive unit, the effect of the synchronized rotation of all the armature inserts approximates a central armature without the attendant drag. The mu metal insulation on the cavities ensure that the north poles and south poles only see a narrow segment of the opposing fields coming through the wire in the wire slot due to current flow in the slots.

The induction coil slots and armature inserts are shown in various illustrations in groups of three coil slots/armature inserts arranged around the circumference of the stator insert although different numbers of groupings can be used. The three north pole magnets and the three south pole magnets of the various groups spin in a sequential or synchronized fashion. Each group of poles occupies a 45° span of the circumference and are sequenced such that, as they are cycled or rotated by the drive unit, a moving magnetic field is created over the coil slots. The north pole armature inserts rotate in sequence over the superior portion of the coil and south pole armature inserts rotate in sequence over the inferior portion of the coil. By superior and inferior, reference is made to the portions of the electrical coils that are closer and farther, respectively from the positive terminal of the coil. It should be noted that in the core of larger equipment, permanent magnets of the armature inserts, which can be made from, for example, neodymium or the like, can be replaced by small bipolar wound inductive magnetic armatures for improved cost.

The following detailed description provides an understanding of embodiments as illustrated and described herein below. Exemplary embodiments are provided that allow electric energy to be generated based on movers that are directly or indirectly driven by conventional fossil fuel energy sources. The greatly increased efficiency of the aspects of embodiments described herein can result in reduced consumption of fossil fuel supplies and reduced output of greenhouse gases. Accordingly, a high efficiency generator is provided that shields or separates the drag creating magnetic forces from one another so that upwards of 80% of the driving energy conventionally lost to magnetic drag is converted to electric power.

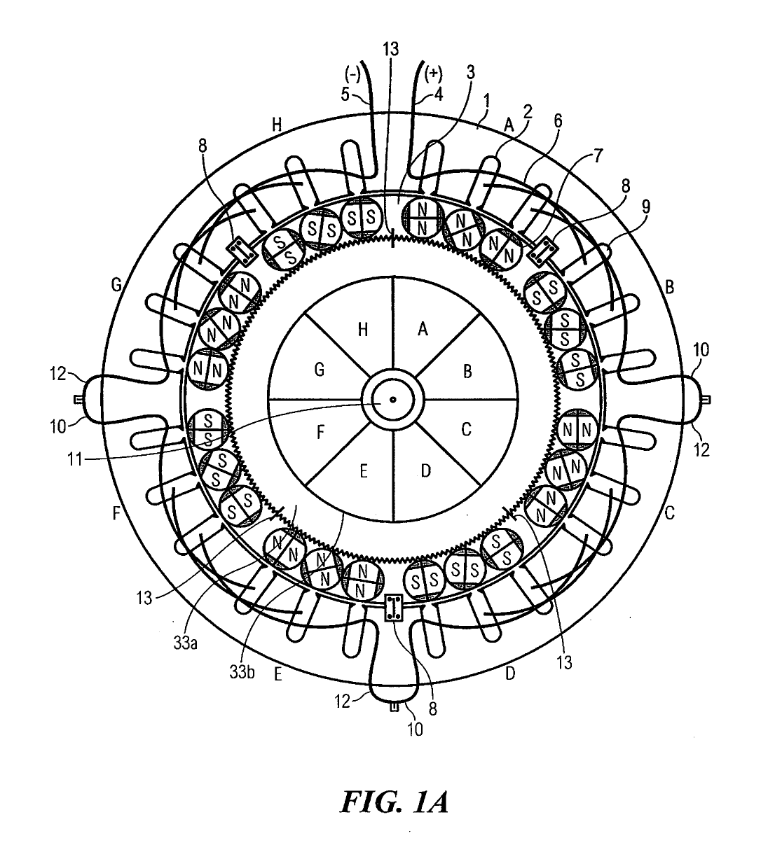

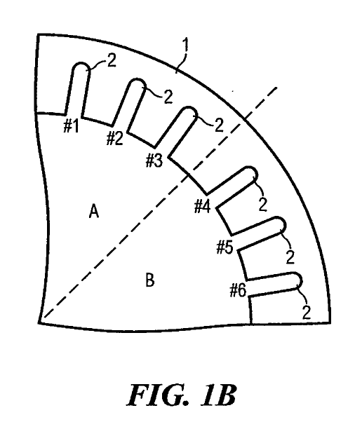

With reference to the drawings, FIG. 1A shows an end view of a stator 1 containing an exemplary stator insert 3 including cavities for accommodating the armature inserts 7 as described hereinabove. Stator 1 can be constructed from laminated ferromagnetic iron or steel and can contain a series of superior slots 2, which can accommodate various portions of a coil 6 on the positive terminal side and can be exposed to the armature inserts 7 having N poles and can contain inferior slots 9, which can accommodate various portions of coil 6 away from the positive terminal side and exposed to the armature inserts 7 having S poles. The slots can be located on the inner circumference, the outer circumference, or both the inner and outer surface. As is plainly visible in the depiction shown in FIG. 1A, the stator windings are made up of four groups of coils 6 distributed in sectors A-H, with two sectors per group and with each group having three coils 6. It will be noted that for each quadrant, constituted, for example, of sectors A-B, C-D, E-F, and G-H, the slots can be numbered as shown in FIG. 1B for the purposes of the description provided hereinbelow. It will be appreciated that while the slot numbering is shown for sectors A-B, the same numbering can be applied in all quadrants. It will be further appreciated that while a total of eight sectors A-H are shown, an even number N more or less than eight sectors can be used and, while three slots and corresponding armature inserts are shown per sectors, a greater or lesser number of slots and corresponding armature inserts can be used.

Thus, for all quadrants A-B, C-D, E-F, and G-H, the superior portion of the first winding group of coils 6 can be inserted into slot #1 and the inferior portion into slot #4, the superior portion of the second winding group of coils 6 can be inserted into slot #2 and the inferior portion into slot #5. The superior portion of the third winding group of the coils 6 can be inserted into slot #3 and the inferior portion into slot #6, and so on. It will be understood that the remaining winding groups of the coils 6 are placed into the wire slots throughout the remainder of the periphery of the stator 1 in the same fashion. Lead 4 of the first winding group remains free and becomes generator neutral. The winding groups of each quadrant are coupled with the adjoining groups by making a connection between power lead 10 of each quadrant to the neutral 12 for each quadrant. The power lead 5 in the final quadrant, sectors G-H, becomes the power lead of the generator when all of the coil groups are wired together.

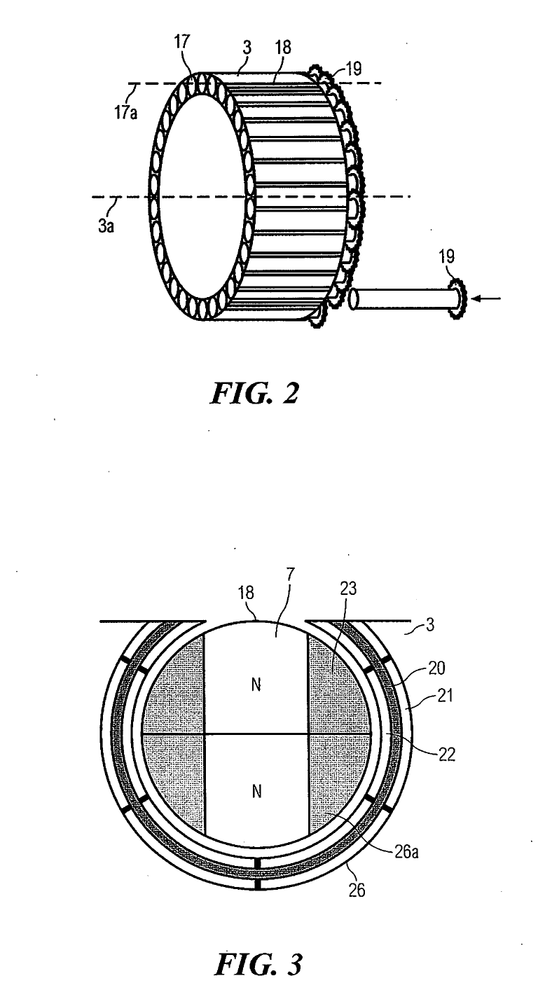

In accordance with an embodiment, as illustrated, for example, in FIG. 2, stator insert 3 can be constructed from, for example, stainless steel and can contain a number of circular or cylinder shaped cavities 17 that are arranged around the circumference of and pass through the body of stator insert 3. Each cavity 17 has an axis 17a that is parallel to a common central axis 3a of the stator insert 3 and the stator 1 and has a slot shaped opening 18 through the outer circumferential surface of the stator that can be positioned in proximity to each wire slot in stator 1, when inserted thereinto. The opening 18 can be formed by “unroofing” cavity 17, or removing the outer surface of the stator insert 3, through machining or the like, or by machining cavities 17 such that their radius exceeds the outer circumference dimension of the stator insert 2. Alternatively, the stator insert 3 can be formed in a different manner such as through casting or the like of a combination of metal fabrication processes. The width of the opening 18 can thereby be constructed to match the width of the wire slot opening in stator 1.

It will further be seen that cavity 17 can accommodate a containment sleeve and bearings (not shown) for containing an armature insert 7 including permanent magnets. The containment sleeve and the armature inserts 7 fixedly contained therein are rotated in a determined sequence such that the rotating magnetic field produced by the effects of the synchronized rotation of each armature insert approximates the magnetic effects of a single central rotating armature, but without the electromagnetic drag and without the need for brushes, commutator or the like. The armature inserts 7 secured in the containment sleeve can be rotated on their axis via gears 19. A more detailed description of the containment sleeve arrangement, gears 19 and drive unit will be provided hereinafter.

A more detailed cross sectional view of an armature insert 7 fully inserted into a shielded cavity 17 is shown and described in connection with FIG. 3. Therein an end view of a cavity 17 in stator insert 3 is shown having an armature insert 7 with like-pole permanent magnet pairs. The cavity 17 has an opening 18 as described and can include shield 26, which lines the cavity such that the magnetic flux emanating from the permanent magnets of the armature insert 7 is shielded except when rotated over opening 18. The shield 26 can be constructed with a series of laminations such as layer 21, which can be a steel layer, such as non-magnetic austenitic steel, layer 20, which can be a mu metal layer, and layer 22, which can also be a steel layer, such as non-magnetic austenitic steel. The permanent magnets of armature insert 7 can be glued into containment sleeve 26a.

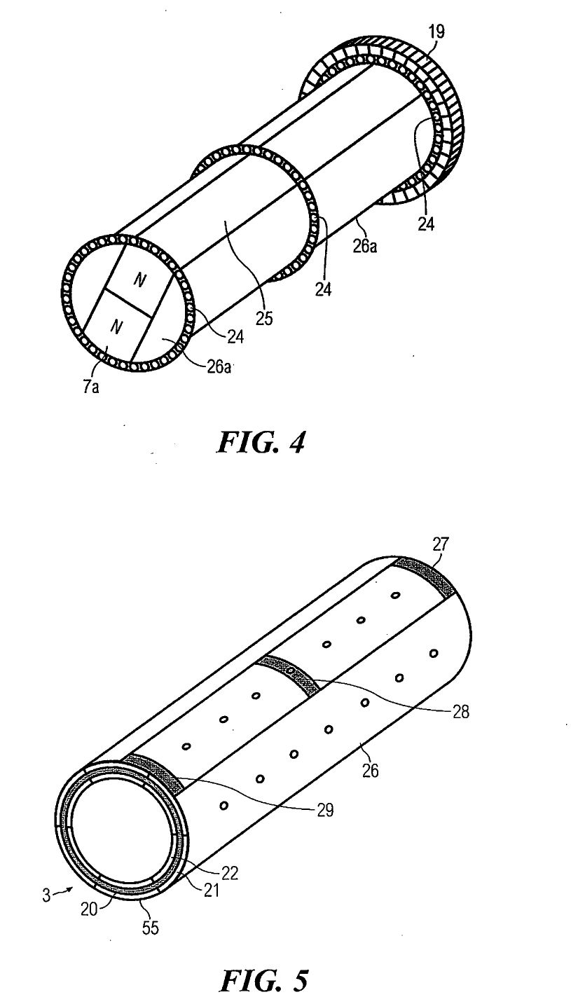

A more detailed view of an exemplary containment sleeve 26a is shown and described in connection with FIG. 4. The containment sleeve 26a primarily includes retaining and containment portions on either side of the permanent magnets 7a. An open slot 25 allows magnetic flux from the permanent magnets 7a to move through the shield slot 18 and move past the windings in order to induce a current in the exposed coils 6. Containment sleeve 26a can be considered a part of the armature insert 7 and can rotate inside laminated shield 26 on bearings 24 that can be driven through a drive unit contacting gears 19.

Details associated with the placement of containment sleeve 26 within the stator insert 3 are shown and described in connection with FIG. 5. A superior lateral projection shows the laminated shield 26 for accommodating and shielding an armature insert 7 (not shown) and associated containment sleeve 19 (also not shown). Bearing rests 27, 28 and 29 for accommodating bearings 24 shown and described hereinabove in connection with FIG. 4 are distributed along the length of containment sleeve 26.

As described herein above, the containment sleeve 26 can be provided with gears 19. Complimentary gears 33 associated with an exemplary drive unit 10 can mesh with gears 19 to rotate the armature insert. Gears 33 can rest on a support structure 33a and can be provided that interface with wheel 33b, shown in FIG. 1. The drive unit 10 can be driven by shaft 11. End bells 30 and 34 can be used to cover the opening once the stator and generator are assembled and can be secured through fastener holes 32 and shaft 11 can protrude through bearing 31 and 35 as further set forth herein below. Also shown in common central axis 3a.

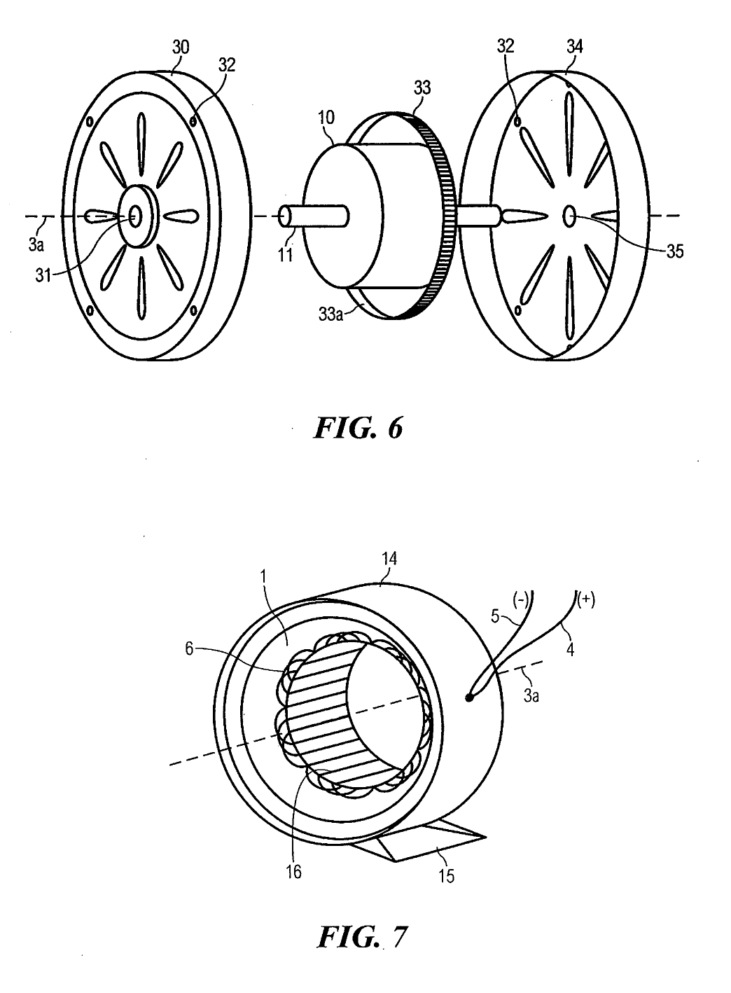

A partially completed generator unit is shown and described in connection with FIG. 7. In an embodiment, stator iron 1 can be pressed into the generator housing 14. The leads 4 and 5 from coils 6 are pulled through to the outside of shell 14. The magnetic bodies associated with armature inserts 7 are aligned in sequence prior to pressing stator insert 3 into the stator 1. When the armature inserts 7 are aligned in proper sequence and gear wheel 33a and stator insert 3 are locked together by pins 13 as shown, for example, in FIG. 1. Stator insert 3 can then be pressed into place inside stator 1 and an attachment mechanism 8 can be used to secure the assembly. Lock pins 13 can then be removed. End bells 30 and 34, shown in FIG. 6, are applied by pushing shaft 11 through into bearings 31 and 35. Bolts are then placed through fastener holes 32 and the end bells are secured. Also shown is common central axis 3a.

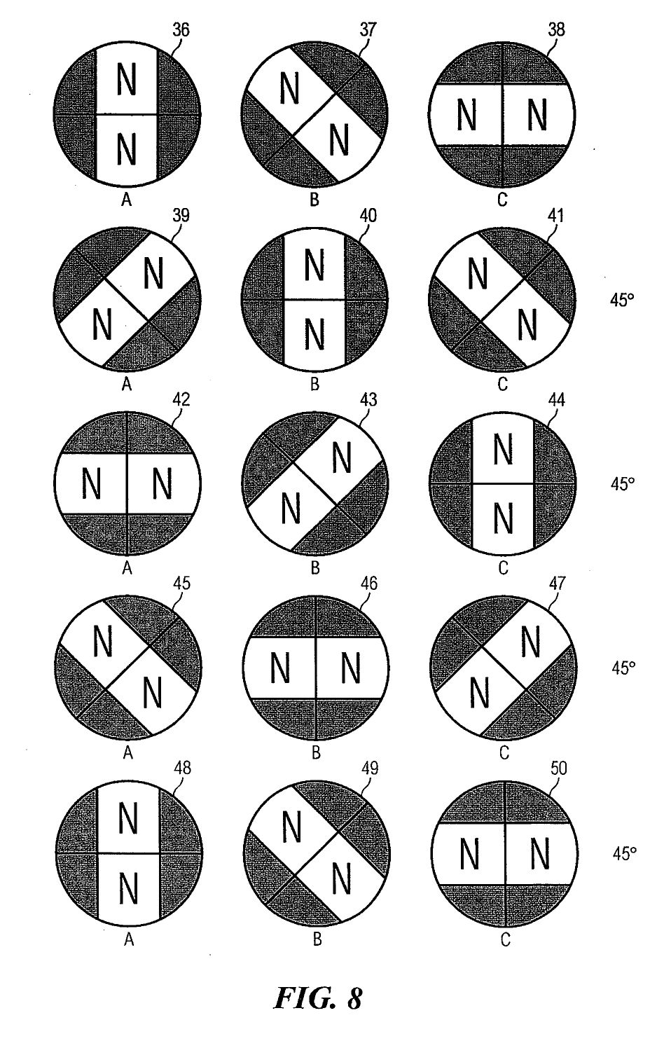

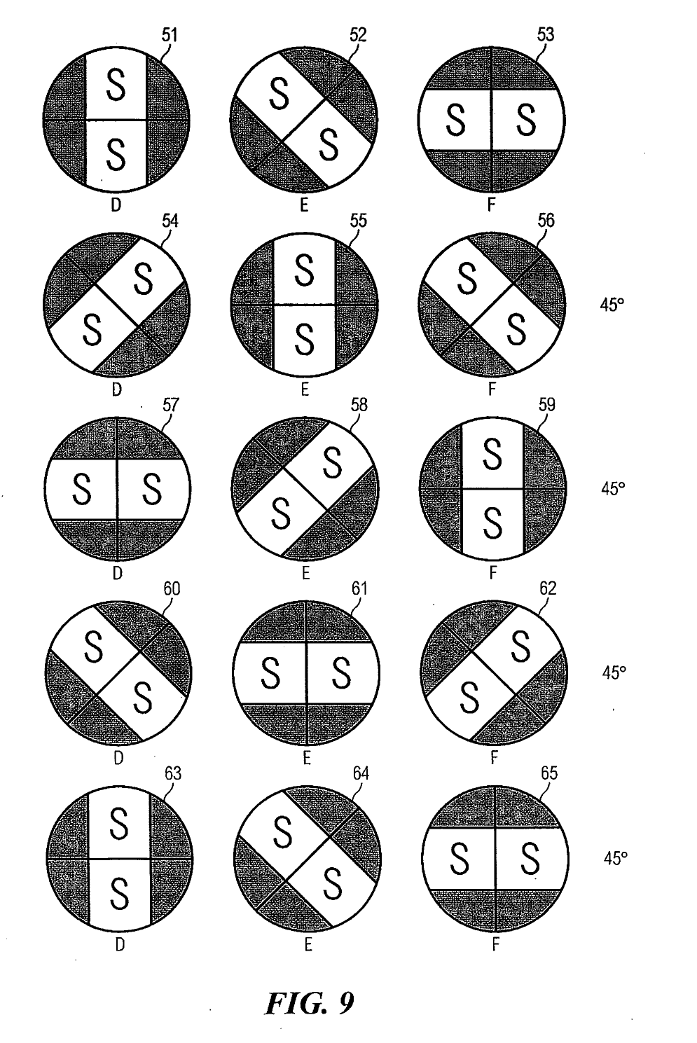

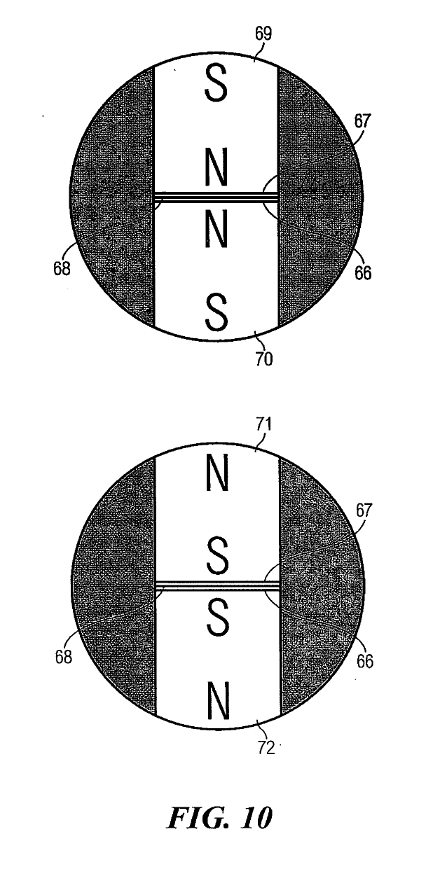

To fully appreciate the operation in accordance with embodiments, FIG. 8 represents the synchronous rotation through 180° of an exemplary group of three north pole magnets A-B-C revealed in 45° increments. FIG. 9 represents the synchronous rotation through 180° of a group of three south pole magnets D-E-F revealed in 45° increments. As described hereinabove, each alternate sector can be provided with three magnets of a certain polarity and the synchronous rotation of the groups of magnets positioned around the circumference of the stator can act together to efficiently induce a current into the windings with a low degree of magnetic drag. It can be seen from FIG. 8, a start position of the three magnets A-B-C is represented by positions 36, 37, and 38 which are themselves offset from one another by 45°. As the magnets A-B-C are synchronously driven, along with the other magnets around the stator, the various illustrations show each magnet A-B-C advanced by 45° as represented by the positions 39, 40, 41; 42, 43, 44; 45, 46, 47; and 48, 49, 50. Similarly, it can be seen from FIG. 9, a start position of the three magnets D-E-F is represented by positions 51, 52, and 53 which are themselves offset from one another by 45°. As the magnets D-E-F are synchronously driven, along with the other magnets around the stator, the various illustrations show each magnet D-E-F advanced by 45° as represented by the positions 54, 55, 56; 57, 58, 59; 60, 61, 62; and 63, 64, 65. FIG. 9 further shows that each pole in the same-pole pair in the individual permanent magnet rotors is insulated from the other by a shield made up of, for example, mu metal sheets 66 and 67, with a ferrous layer 68 sandwiched therebetween as will be described in greater detail hereinafter with reference to FIG. 10.

As previously set forth, armature inserts 7 can be provided with permanent magnets made with bipolar magnetic bodies having two poles of the same magnetic polarity exposed on each end. Such a configuration allows exposure of either respective south poles on each exposed end of the dipole or respective north poles on each exposed end of the dipole. FIG. 10 shows a magnetic body 69 that can be attached or otherwise secured in a permanent or semi-permanent manner by some form of securing agent, such as epoxy cement, or the like, to one side of shield 67, which can be a mu metal shield. On the other side, magnetic body 70 can be attached or otherwise secured to one side of shield 66, for example, with epoxy. Each of the other sides of shields 66 and 67 can be attached or otherwise secured, such as using epoxy cement, to sheet 68, which can be a ferrous sheet. The above-described arrangement allows only magnetic energy having a south pole magnetic polarity to be exposed over wire slots of the stator during rotation of the armature insert 7. Similarly, magnetic body 71 and 72 can be secured to shield 67 and 66 respectively and sheet 68 can be sandwiched therebetween. The arrangement allows only magnetic energy having a north pole magnetic polarity to be exposed over wire slots of the stator during rotation of the armature insert 7. It should be noted that the above described inventive arrangement allows DC current to be generated with very little drag at variable speeds making in a manner suitable to, for example, boost the efficiency of plug-in electric or hybrid gas-electric cars.

While embodiments have been described and illustrated, it will be understood by those skilled in the technology concerned that many variations or modifications in details of design or construction may be made without departing from the present invention. For example, while the permanent magnets are described herein as being made from neodymium, samarium-cobalt magnets could also be used particularly where high temperature applications are needed. Further, while motor windings are described herein as being arranged in coil groups of three per sector, other arrangements are possible and winding can be accomplished in a variety of ways such as wound copper conductors, insulated winding bars and the like, without departure from the inventive gist.

1. A method for reducing drag in a brushless direct current (DC) electric generator comprising:
distributing armature insert members along an outer periphery of a stator insert, the stator insert being press fit into a stator having induction windings arranged in slots around the inner periphery thereof, the armature insert members including permanent magnet rotors each having a pair of pole sections, each pole section of the pair having a same one of a first magnetic polarity or a second magnetic polarity;
offsetting the alignment of the armature insert members in 45 degree increments from one to the next thereof; and
rotating the armature insert members together in a synchronized manner such that the pole sections of the armature insert members are sequentially rotated into alignment with the slots so as to provide a moving excitation field having maximum flux density in the induction windings to induce a current flow therein,
wherein the stator insert and the stator are divided into N equally spaced sectors by radii emanating from a common center point on a common central longitudinal axis and first ones of the armature insert members of the first magnetic polarity are inserted into first positions along the outer periphery of the stator insert corresponding to first ones of the N sectors and second ones of the armature insert members of the second magnetic polarity are inserted into second positions along the outer periphery of the stator insert corresponding to second ones of the N sectors, the first ones and the second ones of the N sectors arranged in alternating relation.

2. The method of claim 1, wherein the slots and the armature insert members are axially aligned along respective lengthwise axes thereof such that a lengthwise axis of each of the armature insert members is in normal alignment with a respective depthwise axis of each of the slots.

3. The method of claim 1, further comprising magnetically shielding the armature insert members within the stator insert such that flux generated thereby is directed into the slots so as to minimize flux leakage and magnetic drag.

4. The method of claim 1, wherein the distributing the armature insert members further includes inserting the armature insert members into respective openings provided in the first and the second stator sections, the respective openings arranged in lengthwise alignment with the slots, to partially shield the first and the second members, and having a longitudinal opening corresponding to a longitudinal opening of the slots, to provide magnetic communication with the corresponding longitudinal opening in the slots.

5. The method of claim 1, wherein the rotating the armature insert members in a synchronized manner further includes rotating the armature insert members such that first ones of the armature insert members in a first sector and having the pair of pole sections of the first magnetic polarity are sequentially rotated into alignment with the slots in the first sector while the second ones of the armature inserts members in a second sector and having the pair of pole sections of the second magnetic polarity are sequentially rotated into alignment with the slots associated with the second sector so as to provide a moving excitation field having maximum flux density in the induction windings to induce a current flow therein.

6. The method of claim 1, wherein N is equal to 8.

7. The method of claim 1, further comprising driving the first and second members in a synchronized manner.

8. The method of claim 1, further comprising forming the pole sections from neodymium.

9. The method of claim 1, further comprising forming the pole sections from samarium-cobalt.

10. An electromagnetic assembly for a brushless direct current (DC) electric generator comprising:
a stator having a plurality of slots arranged on a stator periphery thereof the slots having a lengthwise and depthwise axis, each of the plurality of slots having induction coil windings disposed therein; and
a stator insert having a plurality of cavities on a stator insert periphery, the plurality of cavities each having a longitudinal axis aligned with respective longitudinal axes the plurality of slots, the stator insert pressed into the stator; and
a plurality of armature insert members inserted into the cavities, each of the plurality of armature insert members having permanent magnet rotors, each permanent magnet rotor having a pair of magnetic pole sections, each pole section of the pair having a same one of a first magnetic polarity or a second magnetic polarity, each of the plurality of armature insert members corresponding each of the plurality of slots, each of the armature insert members being capable of rotating about a longitudinal axis through a drive gear provided on an end thereof, each of the plurality of the armature insert members disposed respectively above each of the plurality of the slots such that the induction coil windings disposed in the plurality of slots are exposed to magnetic flux generated by the magnetic pole sections,
wherein the plurality of armature insert members are offset from each other by 45 degrees and are capable of rotating in synchronized relation such that such that the pole sections of the armature insert members are sequentially rotated into alignment with the slots so as to provide a moving excitation field having maximum flux density in the induction windings to induce a current flow therein, and
wherein the stator insert and the stator are divided into N equally spaced sectors by radii emanating from a common center point on a common central longitudinal axis and first ones of the armature insert members of the first magnetic polarity are inserted into first positions along the outer periphery of the stator insert corresponding to first ones of the N sectors and second ones of the armature insert members of the second magnetic polarity are inserted into second positions along the outer periphery of the stator insert corresponding to second ones of the N sectors, the first ones and the second ones of the N sectors arranged in alternating relation.

11. The electromagnetic assembly of claim 10, further comprising a back iron disposed around an outer periphery of the stator.

12. The electromagnetic assembly of claim 10, wherein each of the cavities has an opening positioned over the slots.

13. The electromagnetic assembly of claim 10, wherein each of the plurality of armature insert members includes a containment sleeve that shields the stator insert from magnetic fields produced by each of the armature insert.

14. The electromagnetic assembly of claims 12 and 13, wherein the containment sleeve is made from alternating layers of mu metal and austenitic steel.

15. The electromagnetic assembly of any of the preceding claims, wherein each of the stator and the stator insert has a substantially circular shape.

16. The electromagnetic assembly of claim 10, wherein each of the plurality of armature insert members includes a containment sleeve having one or more bearings to support rotation of the containment sleeve and the contained armature insert member.

17. The electromagnetic assembly of claim 10, wherein each of the plurality of armature insert members includes a containment sleeve having one or more bearings to support rotation of the containment sleeve and the contained armature insert member and a gear coupled to an end thereof for rotating the containment sleeve and the contained armature insert about the longitudinal axis.

18. The electromagnetic assembly of any of the preceding claims, wherein the pole sections are formed from neodymium.

19. The electromagnetic assembly of any of the preceding claims, wherein the pole sections are formed from samarium-cobalt.
